(19) United States
(12) Patent Application Publication
(10) Pub. No.: US 2007/0150360 A1
(43) Pub. Date: Jun. 28, 2007

(54) System and method for purchasing goods being displayed in a video stream

(75) Inventor: Jalem M. Getz, Waukesha, WI (US)

Correspondence Address: FOLEY & LARDNER LLP, 777 EAST WISCONSIN AVENUE, MILWAUKEE, WI, 53202-5306, US

(73) Assignee: BUYSEASONS, Inc.

(21) Appl. No.: 11/292,577

(22) Filed: Dec. 2, 2005

(51) Int. Cl. G06Q 30/00

(52) U.S. Cl. 705/26

(57) ABSTRACT

A purchasing system correlated to the display of video content in a video stream. The purchasing system includes a video stream display configured to display a video stream including video content and a purchasing interface configured to display an item available for purchase based on the video content.

### BACKGROUND OF THE INVENTION

Computers users are increasingly using their computing systems to make purchases over the Internet. Users utilize a web browser to enter the web address of a retailer's web site from whom they wish to make a purchase. On the retailer's web site, the retailer configures one or more web pages to display the goods that the retailer is offering for sale. The user is able to select the items to be purchased and set up payment entirely over the Internet.

Users and retailers may enhance the Internet shopping experience with downloaded video content. Retailers may provide a link on their web page allowing a user to download a video clip related to the product being viewed. For example, a user viewing a web page of a DVD retailer may be able to download a video clip showing a portion of the DVD that they are considering purchasing. The user must actively seek out the retailer's web page and select a link offered by the retailer to access the video content.

Increasingly, computer users are viewing video content that may be downloaded to a home user's computing system over the Internet. The video content may include video programs directed toward a wide variety of content, such as news, sports, entertainment, shopping, etc. The video content may be selected by the user such that the video content is specifically related to a field of interest of the user.

What is needed is a system and method for enabling a user to purchase goods currently being displayed in a video stream. What is further needed is such a system and method configured to automatically provide a purchasing interface based the content of the video stream. What is yet further needed is such a system and method configured to allow the user to interactively control the video stream to target a product of interest.

### SUMMARY OF THE INVENTION

One embodiment of the invention relates to a purchasing system which includes a video stream display configured to display a video stream including video content and a purchasing interface configured to display an item available for purchase based on the video content.

Another embodiment of the invention relates to a method for providing a purchasing interface based on video content in a video stream. The method includes the steps of receiving a video stream, determining video content based on the video stream, and configuring a purchasing interface based at least in part on the video stream.

Yet another embodiment of the invention relates to a purchasing system. The purchasing system includes a video stream display configured to display a video stream including video content. The video content is related to an item available for purchase. The system further includes a purchasing interface configured to display an item available for purchase based on the video content. The purchasing interface is further configured to correlate the display of the item with the display of the video content in the video stream display.

This summary and the following detailed description are directed to certain specific embodiments of the invention. The invention is not limited to the particular embodiments and applications described herein. The invention is defined only by the claims.

### BRIEF DESCRIPTION OF THE DRAWINGS

FIG. 1 is a block diagram illustrating an Internet retail system configured to enable a computer user to purchase one or more goods being displayed in a video stream, according to an exemplary embodiment;

FIG. 2 is a block diagram illustrating a retail computing system configured to implement a system and method for purchasing goods being displayed in a video stream, according to an exemplary embodiment;

FIG. 3 is a purchasing enabled video player including a video content display and a purchasing interface, according to an exemplary embodiment;

FIG. 4 is a flowchart illustrating a method for allowing a user viewing a video stream to purchase one or more items being displayed in the video stream, according to an exemplary embodiment.

### DETAILED DESCRIPTION OF THE PREFERRED EMBODIMENTS

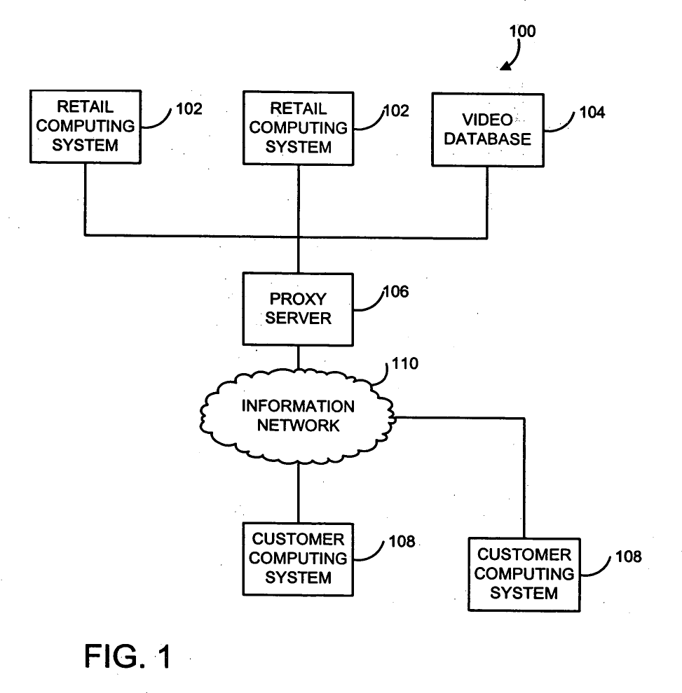

Referring to FIG. 1, a block diagram illustrating an Internet retail system 100 configured to enable a computer user to purchase one or more items being displayed in a video stream is shown, according to an exemplary embodiment. Internet retail system 100 includes one or more retail computing systems 102, a retail computing video database 104, a proxy server 106, and customer computing systems 108. Systems 102-108 are configured to communicate using one or more communication networks 110.

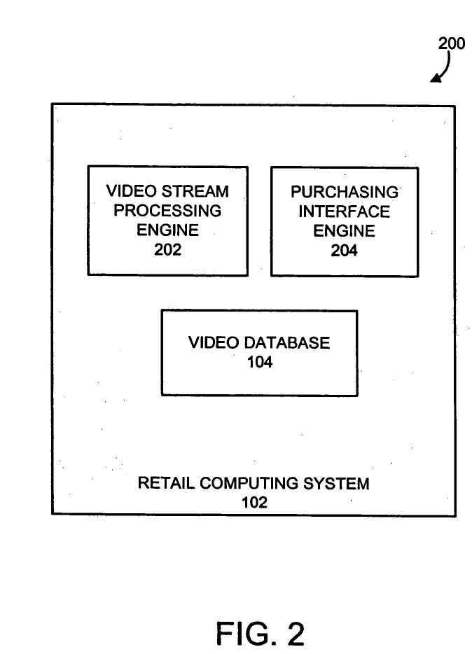

Retail computing systems 102 and customer computing systems 108 may each be any type of computing system including, but not limited to, a personal computer, a laptop computer, a handheld computer; a portable computing device, a cellular telephone, and a portable video player. Retail computing systems 102 may be configured to send and receive data with customer computing systems 108 through proxy server 106. Retail computing system 102 is described in further detail below with reference to FIG. 2.

Video database 104 may be any type of database configured to store and provide video stream data upon request. Video stream data includes data that may be used to play a video to a user using a video player. Video stream data includes video content which is a description of what is video displayed on the video player is showing. According to an exemplary embodiment, video database 104 may be a component of one or more of retail computing systems 102. Video database 104 may alternatively be implemented as a streaming video source. Exemplary streaming video sources may include a live streaming video feed, video received directly from a satellite feed, etc.

Proxy server 106 may be a computing device configured to implement a computer network service that allows customers to make indirect network connections to other network services. Specifically, customer computing system 108 may be configured to connect to the proxy server and request a connection, file, or other resource available on a retail computing systems 102. The requested file or other resource may be the streaming video content stored in video database 104. Proxy server may be implemented using hardware, software, or some combination thereof. Although shown in FIG. 1 as a separate system, proxy server 106 may alternatively be implemented as a component within system 102.

Although computing system 102 is shown in FIG. 1 as directly connected to database 104 and proxy server 106, these systems may alternatively be connected through a second communication network, such as an Internet, a local area network (LAN), a wireless network, etc. Further, system 100 may include more, fewer, and/or a different configuration of components configured to implement the systems and perform the methods described herein.

In operation, a retail customer may utilize any one of customer computing system 108 to access video content through retail computing systems 102. Retail computing systems 102 may be configured to provide the video content in a streaming video format. Retail computing systems 102 may further be configured to provide a purchasing interface to system 108. The purchasing interface may be an interface configured to allow the retail customer to purchase an item associated with the video content being provided in the video stream. For example, retail computing system may be associated with a retailer of women's fashions. The video content associated with retail computing system 102 may include a video of a fashion show including models wearing the women's fashions offered by the retailer. Retail computing system 102 may be configured to provide the video content to customer computing system 108 for display on system 108. Retail computing system 102 may further be configured to provide a purchasing interface allowing a user viewing the video content using system 108 to also purchase an item featured in the video content. The systems and methods for providing the video content and associated purchasing interface are described in further detail below with reference to FIGS. 2-4.

Referring now to FIG. 2, a block diagram 200 illustrating a retail computing system 102 configured to implement a system and method for purchasing goods being displayed in a video stream is shown, according to an exemplary embodiment. System 102 includes a video stream processing engine 202, a purchasing interface engine 204, and video database 104. System 102 may further include more, fewer, and/or a different configuration of components configured to perform the functions described herein.

Video stream processing engine 202 may be a computer program stored in a memory of computing system 102 and run by a computer processor of computer system 102. Video stream processing engine 202 may be configured to process a video stream to determine the content of the video stream, hereinafter referred to as video content. The video content includes a description of what is shown in a video display when the video stream is displayed using a video stream player. The video stream that is processed may be retrieved from video database 104 or received from an external source

Determining the video content may be implemented using any of a variety of methods. For example, a received video stream may be configured to include one or more video content descriptors. A video content descriptor may be information placed on the video stream that will allow video stream processing engine 202 to identify the current video content of the video stream without interfering with the normal operation of the video stream. An encoding system may be used in creating the video stream to encode the video content descriptor on the video content stream. For example, where the video stream includes the women's fashion show and the current video content is a dress by designer A, the encoding system may be used to encode a video content descriptor indicating that the video content currently in the current video stream is the dress from designer A. The video content indicators may be encoded during the creation of the video stream, during a preprocessing of the video stream, during playback of the video stream, etc.

Alternatively, determining the video content may include receiving a timing schedule of video content associated with the video stream, where differing video content in the video stream is associated with a particular time. For example, video stream processing engine 202 may receive a schedule indicating that a dress from designer A is shown in the first five minutes of the video stream, a dress from designer B is shown in the second five minutes, and so on.

According to yet another alternative, video processing engine 202 may be configured to perform a video image processing function on the video stream to recognize one or more images in the video stream. For example, video processing engine 202 may be configured to include a database of known images. The known images may be items currently offered for sale by the retailer. Video stream processing engine 202 may be configured to recognize whenever one of the known images is currently being displayed in the video stream using standard image matching or pattern recognition techniques. For example, where the video stream is an entertainment program, and the video content shows a particular actress wearing a dress from designer A, system 102 may be configured to recognize the dress from designer A in the video stream using pattern recognition techniques.

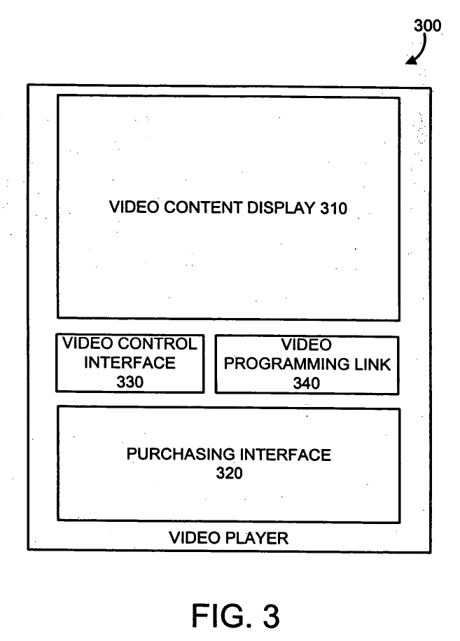

Purchasing interface engine 204 may be a computer program resident on computer system 102 configured to provide the video stream to a user and to provide an interface configured to allow the user to purchase an item displayed in or associated with the content of the video stream. Accordingly, purchasing interface engine 204 may be configured to receive an indication of the video content currently being shown in the video stream from video stream processing engine and to configure a purchasing interface to allow a user viewing the interface to make a purchase based on that video content. A detailed description of the purchasing interface is provided below with reference to FIG. 3.

The indication of the video content may include any information related to the video content currently being displayed in the video stream. For example, the video content indication may include a specific identification, such as textual description of an item, a stock keeping unit (sku) number, etc. or a generic description of an item, such as women's high fashion, Halloween costume, a Halloween costume of a particular cartoon character, an identification of the cartoon character, etc.

Configuring the purchasing interface based on the video content indication may be dependent of the type of the video content indication. For example, where the video content indication is a description of the particular item, configuring the purchasing interface may include providing a “Buy Now” button configured to allow the user to initiate a purchasing process for the particular item.

However, where the video content indication includes a more general indication of the video content, purchasing interface engine 204 may be configured to correlate the video content with one or more products prior to configuring the purchasing interface based on or more additional processing functions. For example, where the video content indicator is the identity of a cartoon character, purchasing interface engine 204 may be configured to determine if the time of year is close to Halloween. If it is near Halloween, engine 204 may configure purchasing interface to display Halloween costumes for the particular cartoon character. If it is not close to Halloween, purchasing interface engine 204 may be configured to display toys, food items, etc. that are branded based on the cartoon character.

Purchasing interface engine may further be configured to correlate the video content indicator to more than one particular product and may configure the purchasing interface to display multiple products or to cycle through displays of the different products. For example, using the above example where the video content indicator is the identity of a cartoon character, purchasing interface engine 204 may configure the purchasing interface to allow a user to purchase a Halloween costume based on the cartoon character for 20 seconds and then configure the purchasing interface to allow a user to purchase toys based on the cartoon character for the next 20 seconds, and so on.

Configuring the purchasing interface may include configuring the interface to display the item offered for sale and providing a user input field on the purchasing interface. The user input field may include a “Buy Now” button, a “Place Bid” field and button, a quantity field, etc. Configuration of the purchasing interface is described in further detail below with reference to FIG. 3.

Referring now to FIG. 3, a purchasing enabled video player 300 including a video content display 310 and a purchasing interface 320 is shown, according to an exemplary embodiment. Video player 300 is configured to enable a user to view video content in a video stream on video content display 310 and to enable the user to be able to purchase one or more items based on the video content using the purchasing interface 320. Video player 300 may optionally include additional controls and/or features such as a video control interface 330 and a video content programming schedule link 340.

Video player 300 may be implemented as a web page configured to be displayed on customer computing system 108 using a standard internet browsing application. According to an exemplary embodiment, a user of customer computing system 108 may enter a web address associated with retail computing system 102 into the address field of an internet browsing application. In response, retail computing system 102 may be configured to provide a web page configured to implement video player 300. Video player 300 may be implemented using any of a variety of known techniques for creating a webpage including one or more embedded applications. For example, video player 300 may be created using hypertext markup language (HTML), JavaScript, extensible markup language (XML), etc.

Video content display 310 may be a display created by any type of embedded application in video player 300 configured to allow a user to view video content in a video stream. The video content may be either specifically selected by a user or may be displayed according to a defined schedule, such as broadcasted video content. Customer computing system 108 and/or the video stream may be configured such that video player 300, including purchasing interface 320, is displayed when the user selects a video stream for display.

Purchasing interface 320 may be an interface configured to allow a user to purchase or an item or initiate a purchasing process. Purchasing interface 320 may be implemented using any of a variety of applications, such as the Macromedia Flash Player by Macromedia, Inc. of San Francisco, Calif.

Purchasing interface 320 may be configured to include a “Buy Now” button. Selection of the buy now button may result in automatic completion of a purchase where the user has previously entered purchasing information such as a credit card number, shipping address, billing address, etc. Where the user has not previously entered the information, purchasing interface 320 may be configured to display a purchasing web page configured to allow the user to enter the purchasing information. Purchasing interface 320 may further be configured to include additional buttons configured to allow the user to select other functions, such as emailing a listing of the item to a friend, requesting additional information, displaying related items, add the item to a shopping cart, add the item to a wish list, etc.

Purchasing interface 320 may further be configured to display the item that is being offered for sale. The displayed image may be a video capture of the item from the video content or may be a standard picture showing the item.

Player 300 may further be configured to include video control interface 330 to allow a user of customer computing system 108 to manipulate the video stream. For example, video player controls may be configured to allow the user to go backward within the video stream to review an item that was just shown, skip forward to bypass an item in which the user is not interested, pause the display to better view a particular item, etc. Player 300 may be configured to reconfigure purchasing interface 320 based on the video content shown after user operation of video control interface 330.

Player 300 may further include a video stream programming guide link 340 configured to allow the user to open a new window displaying a programming guide associated with the video stream. The programming guide may include a listing of items that have been displayed based on the video content, items that are scheduled to be displayed in future video content, a listing of available video content, etc. The user may be able to select items of interest from the programming guide to go directly to that portion of the video stream displaying the particular item.

Player 300 may further be configured to include any other features or indicia desired by the retailer. For example, player 300 may include a link to the retailer's web site, a retailer's logo, advertisements, etc.

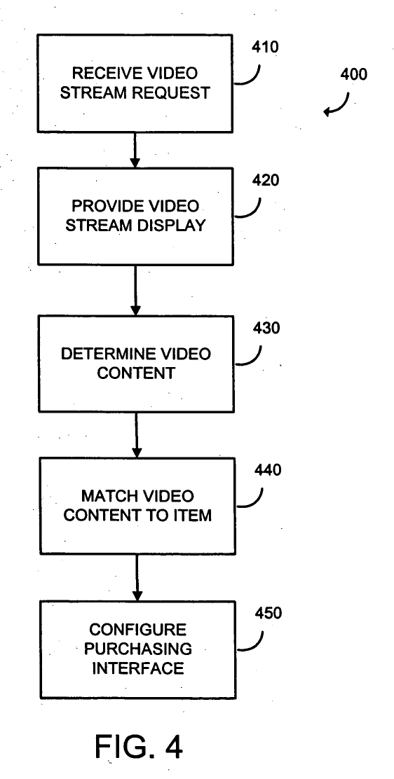

Referring now to FIG. 4, a flowchart 400 illustrating a method for allowing a user viewing a video stream to purchase one or more items being displayed in the video stream is shown, according to an exemplary embodiment. The method may be implemented using a customer computing system 108 by requesting a web page from a retail computing system 102. Although specific method steps are shown and described in a specific order below, it is understood that the method may be performed using additional, fewer, different, and/or differently ordered steps to perform the function described herein.

In a step 410, retail computing system 102 may receive a request for a video stream to be displayed on customer computing system 108 through a web browser. The request may be received based on entry of a web address, a click on a web link offered on a retailer web site, a click on a web page of a third party web site, etc. Step 410 may also be performed any time a user initiates a video stream viewing. For example, video player 300 may be provided as a video stream enhancement any time a video stream is being displayed to the user.

Retail computing system 102 may be configured to provide the video player 300 web page in response to the video stream request in a step 420. Video player 300 may be configured to include both the video stream display 310 and the purchasing interface 320.

During playback of the video stream on customer computing system 108, retail computing system 102 may be configured to scan the streaming video for one or more video content indicators in a step 430. As stated above, scanning the video content may include processing the video stream to detect encoded video content indicators, referencing a video content timetable based on a timing associated with the video stream, etc.

Retail computing system 102 may be configured to match the video content indicator to one or more items available for purchase in a step 440. Matching the video content indicator may include pattern matching, receiving an item description, receiving an item identifier, etc.

To perform the matching step of 440, retail computing system 102 may be configured to maintain an item database of items that are available to be purchased. Where the video content purchasing system is provided by a retailer, the database may contain items sold by the retailer. Where the purchasing system is provided by a third party, retailers may provide the items to the third party to be stored in the database.

Each item listing in the item database may be configured to include additional information associated with the item that is available to be purchased. Exemplary information may a picture of the item to be display on purchasing interface 320, a price for the item, a markdown schedule for the item, a sales period for the item, etc.

After the video content indicator is matched to an item that is available for purchase, retail computing system 102 may be configured to configure purchasing interface 320 to display the item. Upon display, a user may purchase the item using purchasing interface 320. Preferably, the item should be displayed concurrently with the video content featuring that item.

Although specific steps are described as being performed by specific systems, it should be understood that system 100 may be configured such that any system may alternatively perform the functions associated with any other system to perform the functions described herein. For example, although retail computing system 102 is described as scanning the streaming video for one or more video content indicators in step 430, customer computing system 108 may alternatively be configured to perform the scanning.

It should be noted that although flow charts may be provided herein to show a specific order of method steps, it is understood that the order of these steps may differ from what is depicted. Also two or more steps may be performed concurrently or with partial concurrence. Such variation will depend on the software and hardware systems chosen and on designer choice. It is understood that all such variations are within the scope of the invention. Likewise, software and web implementations of the present invention could be accomplished with standard programming techniques with rule based logic and other logic to accomplish the various database searching steps, correlation steps, comparison steps and decision steps. It should also be noted that the word “component” as used herein and in the claims is intended to encompass implementations using one or more lines of software code, and/or hardware implementations, and/or equipment for receiving manual inputs. It is to be understood that any method steps as recited herein (e.g., in the claims) may be performed by a configuration utility (e.g., Java™-based) executed by a computing device based on input by a user. Of course, according to various alternative embodiments, any suitable configuration utility, application, system, computing device, etc. may be used to execute, implement and/or perform method steps as recited in this disclosure (including the claims).

The invention is described above with reference to drawings. These drawings illustrate certain details of specific embodiments that implement the systems and methods and programs of the present invention. However, describing the invention with drawings should not be construed as imposing on the invention any limitations associated with features shown in the drawings. The present invention contemplates methods, systems and program products on any machine-readable media for accomplishing its operations. The embodiments of the present invention may be implemented using an existing computer processor, or by a special purpose computer processor incorporated for this or another purpose or by a hardwired system.

As noted above, embodiments within the scope of the present invention include program products comprising machine-readable media for carrying or having machine-executable instructions or data structures stored thereon. Such machine-readable media can be any available media which can be accessed by a general purpose or special purpose computer or other machine with a processor. By way of example, such machine-readable media can comprise RAM, ROM, PROM, EPROM, EEPROM, CD-ROM or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. When information is transferred or provided over a network or another communications connection (either hardwired, wireless, or a combination of hardwired or wireless) to a machine, the machine properly views the connection as a machine-readable medium. Thus, any such a connection is properly termed a machine-readable medium. Combinations of the above are also included within the scope of machine-readable media. Machine-executable instructions comprise, for example, instructions and data which cause a general purpose computer, special purpose computer, or special purpose processing machines to perform a certain function or group of functions.

Embodiments of the invention are described in the general context of method steps which may be implemented in one embodiment by a program product including machine-executable instructions, such as program code, for example in the form of program modules executed by machines in networked environments. Generally, program modules include routines, programs, objects, components, data structures, etc. that perform particular tasks or implement particular abstract data types. Machine-executable instructions, associated data structures, and program modules represent examples of program code for executing steps of the methods disclosed herein. The particular sequence of such executable instructions or associated data structures represent examples of corresponding acts for implementing the functions described in such steps.

Embodiments of the present invention may be practiced in a networked environment using logical connections to one or more remote computers having processors. Logical connections may include a local area network (LAN) and a wide area network (WAN) that are presented here by way of example and not limitation. Such networking environments are commonplace in office-wide or enterprise-wide computer networks, intranets and the Internet and may use a wide variety of different communication protocols. Those skilled in the art will appreciate that such network computing environments will typically encompass many types of computer system configurations, including personal computers, hand-held devices, multi-processor systems, microprocessor-based or programmable consumer electronics, network PCs, minicomputers, mainframe computers, and the like. Embodiments of the invention may also be practiced in distributed computing environments where tasks are performed by local and remote processing devices that are linked (either by hardwired links, wireless links, or by a combination of hardwired or wireless links) through a communications network. In a distributed computing environment, program modules may be located in both local and remote memory storage devices.

An exemplary system for implementing the overall system or portions of the invention might include a general purpose computing device in the form of a computer, including a processing unit, a system memory, and a system bus that couples various system components including the system memory to the processing unit. The system memory may include read only memory (ROM) and random access memory (RAM). The computer may also include a magnetic hard disk drive for reading from and writing to a magnetic hard disk, a magnetic disk drive for reading from or writing to a removable magnetic disk, and an optical disk drive for reading from or writing to a removable optical disk such as a CD ROM or other optical media. The drives and their associated machine-readable media provide nonvolatile storage of machine-executable instructions, data structures, program modules and other data for the computer.

The foregoing description of embodiments of the invention has been presented for purposes of illustration and description. It is not intended to be exhaustive or to limit the invention to the precise form disclosed, and modifications and variations are possible in light of the above teachings or may be acquired from practice of the invention. The embodiments were chosen and described in order to explain the principals of the invention and its practical application to enable one skilled in the art to utilize the invention in various embodiments and-with various modifications as are suited to the particular use contemplated

What is claimed is:

1. A purchasing system, comprising:
a video stream display configured to display a video stream including video content; and
a purchasing interface configured to display an item available for purchase based on the video content.

2. The system of claim 1, wherein the video content is represented by one or more video content indicators encoded in the video stream.

3. The system of claim 1, wherein the video content is represented by a video content timing schedule.

4. The system of claim 1, wherein the purchasing interface is configured to display multiple items available for purchase based on the video content.

5. The system of claim 1, wherein the video content includes the item available for purchase.

6. The system of claim 1, wherein the system further includes a programming guide configured to allow a user to skip directly to a portion of the video stream having video content related to an item of interest.

7. A method for providing a purchasing interface based on video content in a video stream, comprising:
receiving a video stream;
determining video content based on the video stream; and
configuring a purchasing interface based at least in part on the video stream.

8. The method of claim 7, wherein the video content is represented by one or more video content indicators encoded in the video stream.

9. The method of claim 7, wherein the video content is represented by a video content timing schedule for the video stream.

10. The method of claim 7, further including configuring the purchasing interface to display multiple items available for purchase based on the video content.

11. The method of claim 7, wherein the video content includes the item available for purchase.

12. The method of claim 7, further including providing a programming guide configured to allow a user to skip directly to a portion of the video stream having video content related to an item of interest.

13. A purchasing system, comprising:
a video stream display configured to display a video stream including video content, the video content related to an item available for purchase; and
a purchasing interface configured to display an item available for purchase based on the video content and to correlate the display of the item with the display of the video content in the video stream display.

14. The system of claim 13, wherein the video content is represented by one or more video content indicators encoded in the video stream.

15. The system of claim 14, wherein the video content indicator is a description of a type of item being shown in the video stream display.

16. The system of claim 14, wherein the video content indicator is a general subject matter description for the video content being shown in the video stream display.

17. The system of claim 13, wherein the video content is represented by a video content timing schedule.

18. The system of claim 13, wherein the purchasing interface is configured to display multiple items available for purchase based on the video content.

19. The system of claim 13, wherein the video content includes the item available for purchase.

20. The system of claim 13, wherein the system further includes a programming guide configured to allow a user to skip directly to a portion of the video stream having video content related to an item of interest.
